(19) United States
(12) Patent Application Publication
(10) Pub. No.: US 2025/0375867 A1
(43) Pub. Date: Dec. 11, 2025

(54) AUTOFEED SCREWDRIVER

(71) Applicant: Kyocera Senco Industrial Tools, Inc., Cincinnati, OH (US)

(72) Inventors: Ryan Distler, Amelia, OH (US); Gregory M. Gottlieb, Loveland, OH (US); William D. Rice, West Chester, OH (US)

(73) Assignee: Kyocera Senco Industrial Tools, Inc., Cincinnati, OH (US)

(21) Appl. No.: 19/226,256

(22) Filed: Jun. 3, 2025

Related U.S. Application Data
(60) Provisional application No. 63/656,847, filed on Jun. 6, 2024.

(51) Int. Cl. B25F 5/00; B25B 23/00; B25B 23/04

(52) U.S. Cl. CPC B25F 5/003; B25B 23/0064; B25B 23/045

(57) ABSTRACT

A clutchless autofeed screwdriving tool designed to prevent overdriving screws into a workpiece. A user positions the tool onto a workpiece and presses down on a nosepiece, which then retracts a slide body inside the tool. The tool includes a sensor that, when contacted by a rear portion of the slide body, sends a first signal to a controller to stop a motor. Once the motor stops, a drive bit also stops rotating, thereby preventing overdriving a screw into a workpiece. The user then removes the tool from the workpiece, and the slide body automatically extends. When the slide body moves out of contact with the sensor, the sensor sends a second signal to the controller to start the motor, which then starts the drive bit rotating again.

### CROSS-REFERENCE TO RELATED APPLICATIONS

The present application claims priority to provisional patent application Ser. No. 63/656,847, titled “CLUTCHLESS AUTOFEED SCREWDRIVER,” filed on Jun. 6,2024.

### TECHNICAL FIELD

The technology disclosed herein relates generally to automatic screwdriving equipment and is particularly directed to an autofeed screwdriving tool. Embodiments are specifically disclosed as having a slide body that collapses into the tool during operation, which contacts a depth of drive sensor that sends a signal to stop a motor. When the motor stops, a drive bit also stops rotating, thereby ensuring that a screw is not overdriven into a workpiece. The user then lifts the tool off the workpiece, allowing the slide body to automatically extend and release from contact with the depth of drive sensor, which then sends a second signal to start the motor again, thereby also starting the drive bit rotating again.

### STATEMENT REGARDING FEDERALLY SPONSORED RESEARCH OR DEVELOPMENT

None.

### BACKGROUND

Several manufacturers of power tools sell manually-fed (“single-feed”) screwdriving tools, and some of those manufacturers also sell automatic-feed (or “autofeed”) screwdriving tools. The autofeed screwdriving tools typically use some type of collated strips that hold multiple screws at fairly precise intervals, and these collated strips of screws are fed into an indexing mechanism at the front portion of the autofeed screwdriving tool. The user has to merely place the front tip of the tool against a workpiece, and then pull the trigger on the tool while pressing the tool against the workpiece. This type of tool is well-known, and often used by professional carpenters and other construction workers.

The manually-fed screwdriving tools are used in many other situations, including people who are not necessarily professional construction workers, but nevertheless want to have a power tool for driving screws. Even professional carpenters and other construction workers will sometimes use a non-autofeed screwdriving tool, for certain purposes. This is especially popular in situations where a person already has a manually-fed screwdriving tool, but also purchases an autofeed attachment that can be affixed to the front end of the manually-fed screwdriving tool, thereby converting it into an automatic screwdriving gun. Such attachments also are well-known and popular in many construction situations. In this configuration, the attachment becomes the “front-end tool portion” of the overall tool, and the manually-fed screwdriving tool becomes the “back-end tool portion” (or the “back-end tool”) of the overall tool.

Typical automatic-feed screwdriving tools constantly spin a drive bit during operation. A clutch is typically used to stop the drive bit from overdriving screws into a workpiece. The motor, however, is not automatically stopped, and will constantly drain energy from an attached power source (typically a rechargeable battery pack). FIG. 2 illustrates a prior art clutch 46 as part of a prior art autofeed attachment 215.

### SUMMARY

Accordingly, it is an advantage to provide an autofeed screwdriving tool, in which the tool includes a contact sensor that temporarily turns off the motor to prevent overdriving a screw into a workpiece.

It is another advantage to provide a clutchless autofeed screwdriving tool that reduces both the length and the weight of the tool, while reducing energy between each screw operation.

It is yet another advantage to provide an autofeed screwdriving tool that includes a sensor that signals a controller each drive cycle or each time a screw is driven into a workpiece, thereby allowing the controller to count each drive cycle.

It is still another advantage to provide a clutchless autofeed screwdriving tool that acts like a drill when removing a screw or countersinking a proud screw.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, a method for controlling a drive bit for an autofeed screwdriving tool, in which the method comprises: providing: a handle portion with a user-operated trigger; a motor and a corresponding motor driver circuit; an electrical power source; a system controller, operable to control the tool; a slide body exhibiting an exit end and an opposite, rear portion; a flexible collated strip of screws; a rotatable drive bit; and a motor cutoff subassembly, comprising: a plunger; and a sensor that detects a position of the plunger; engaging the user-operated trigger; starting the rotatable drive bit, by energizing the motor; pressing the slide body against a work surface, until the rear portion contacts and moves the plunger until detected by the sensor; sending, using the sensor, a first signal; and stopping the rotatable drive bit without the use of a clutch.

In accordance with another aspect, an autofeed screwdriving tool is provided, which comprises: a handle portion with a user-operated trigger; a motor and a corresponding motor driver circuit; an electrical power source; a system controller, operable to control the tool; a slide body exhibiting an exit end and an opposite, rear portion, in which the slide body is movably positioned in a feed tube; a flexible collated strip of screws; a drive bit that rotates when the motor is energized; and a motor cutoff subassembly, comprising: a plunger; and a sensor that detects a position of the plunger; wherein: at or near the end of a driving stroke, the rear portion contacts and moves the plunger until the plunger is detected by the sensor, which stops the rotatable drive bit without the use of a clutch; and during at least a portion of a return stroke, the rear portion releases from contact with the plunger, allowing the plunger to move away from the sensor, and if the trigger is actuated, starting the rotatable drive bit.

In accordance with a further aspect, an autofeed screwdriving tool is provided, which comprises: a handle portion with a user-operated trigger; a motor with a corresponding motor driver circuit; a removably attachable battery; a system controller, operable to control the tool; a slide body exhibiting an exit end and an opposite, rear portion, in which the slide body is movably positioned in a feed tube; a flexible collated strip of screws; a drive bit that rotates when the motor is energized; and a motor cutoff subassembly, comprising: a sensor that detects a position of the rear portion of the slide body; wherein: at or near the end of a driving stroke, using a signal from the sensor, the rotatable drive bit is stopped without the use of a clutch, and during at least a portion of a return stroke the rotatable drive bit is started if the user-operated trigger is actuated; and the tool exhibits a reduction in its power consumption between the end of the driving stroke and the start of the return stroke, because the motor is temporarily disabled during this time period.

In accordance with a yet further aspect, an autofeed screwdriving tool is provided, which comprises: a handle portion with a user-operated trigger; a motor and a corresponding motor driver circuit; an electrical power source; a system controller, operable to control the tool; a slide body exhibiting an exit end and an opposite, rear portion, in which the slide body is movably positioned in a feed tube; a flexible collated strip of screws; a drive bit that rotates when the motor is energized; and a motor cutoff subassembly, comprising: a plunger that is movable; and a sensor that detects a position of the plunger; wherein: at or near the end of a driving stroke, the rear portion contacts and moves the plunger until the plunger is detected by the sensor; and the sensor sends a first signal.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a left side elevational view of a clutchless automatic screwdriving tool, as constructed according to the principles of the technology disclosed herein.

FIG. 2 is an enlarged view of a prior art clutch for an automatic screwdriving tool.

FIG. 3 is an enlarged view of a portion of the tool of FIG. 1, showing the clutchless portion of the tool.

FIG. 4 is an enlarged view of a portion the tool of FIG. 1, showing the motor cutoff subassembly.

FIG. 5 is a left side elevational view of the tool of FIG. 1 with the outer housing partially removed, showing the tool in a default or ready position.

FIG. 6 is a left side elevational view of the tool of FIG. 1 with the outer housing partially removed, showing the tool in a driven position.

FIG. 7 is a right side view of the nosepiece in contact with the motor cutoff subassembly, of the tool of FIG. 1.

FIG. 8 is a right side view of the nosepiece not in contact with the motor cutoff subassembly, of the tool of FIG. 1.

FIG. 9 is a rear, left perspective exploded view of the motor cutoff assembly and the nosepiece, of the tool of FIG. 1.

FIG. 10 is a front, right perspective exploded view of the motor cutoff assembly and the nosepiece, of the tool of FIG. 1.

FIG. 11 is a perspective exploded view of the depth of drive sensor subassembly.

FIG. 12 is a side view of the depth of drive sensor subassembly, in which the plunger is not actuated.

FIG. 13 is a side view of the depth of drive sensor subassembly, in which the plunger is actuated.

FIG. 14 is a system block diagram of the tool of FIG. 1, showing some of the major electrical and mechanical components.

FIG. 15 is a system block diagram of a prior art automatic screwdriving tool, showing some of the major electrical and mechanical components, in a view similar to that of FIG. 14.

FIG. 16 is a side view of the tool of FIG. 1, showing the depth of drive at a first setting.

FIG. 17 is a side view of the tool of FIG. 1, showing the depth of drive at a second, different setting.

FIG. 18 is an enlarged view of a portion of an alternative embodiment attachment for an automatic screwdriving tool, showing a clutch and a depth of drive sensor.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

In addition, it should be understood that embodiments disclosed herein include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the technology disclosed herein may be implemented in software. As such, it should be noted that a plurality of hardware and software-based devices, as well as a plurality of different structural components may be utilized to implement the technology disclosed herein. Furthermore, if software is utilized, then the processing circuit that executes such software can be of a general purpose computer, while fulfilling all the functions that otherwise might be executed by a special purpose computer that could be designed for specifically implementing this technology.

It will be understood that the term “circuit” as used herein can represent an actual electronic circuit, such as an integrated circuit chip (or a portion thereof), or it can represent a function that is performed by a processing circuit, such as a microprocessor or an ASIC that includes a logic state machine or another form of processing element (including a sequential processing circuit). A specific type of circuit could be an analog circuit or a digital circuit of some type, although such a circuit possibly could be implemented in software by a logic state machine or a sequential processor. In other words, if a processing circuit is used to perform a desired function used in the technology disclosed herein (such as a demodulation function), then there might not be a specific “circuit” that could be called a “demodulation circuit;” however, there would be a demodulation “function” that is performed by the software. All of these possibilities are contemplated by the inventors, and are within the principles of the technology when discussing a “circuit.”

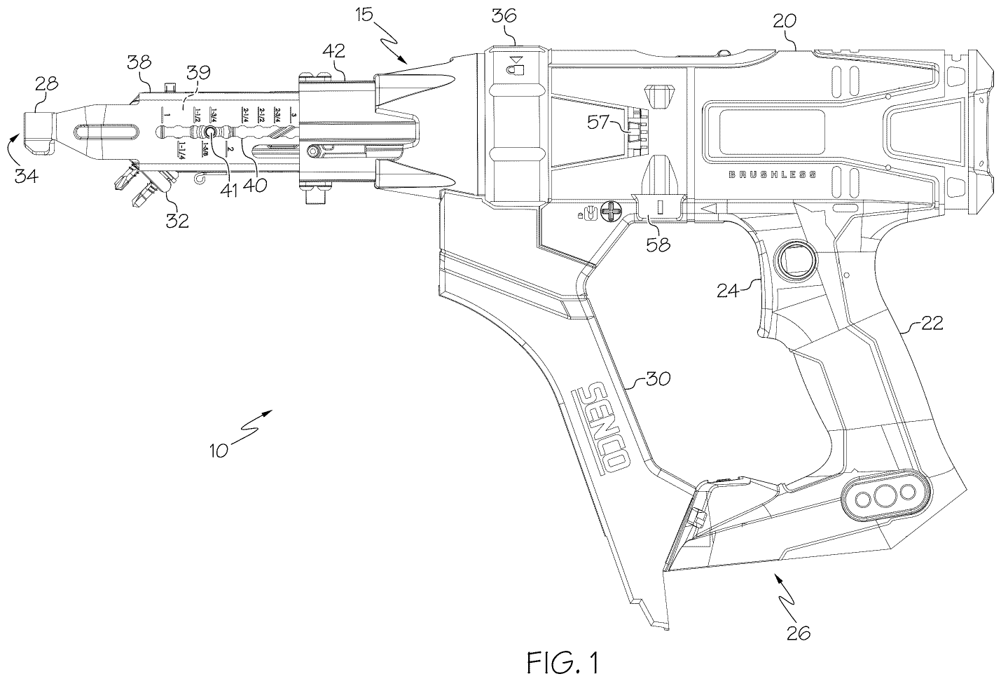

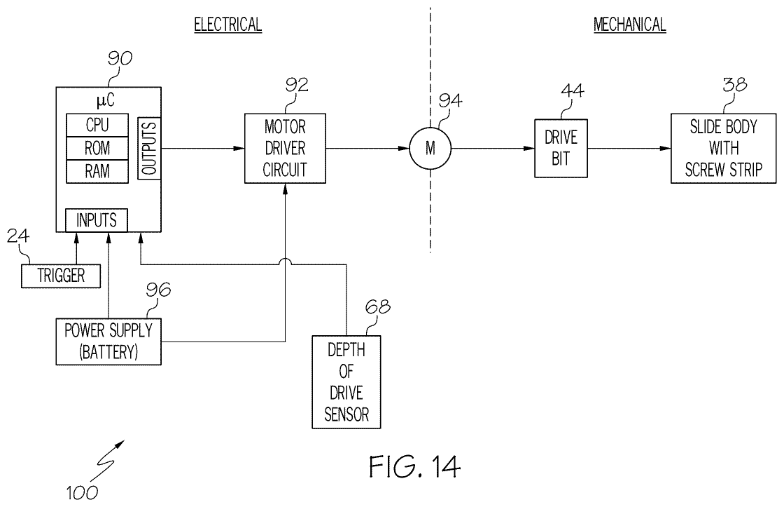

Referring now to FIG. 1, an autofeed screwdriving tool is generally designated by the reference numeral 10. The tool 10 includes an outer housing 20, a handle portion 22, a user-operated trigger 24, and a battery connector portion 26 for an electrical power source, such as a rechargeable battery 96 (see FIG. 14). An autofeed attachment 15 includes a guide 30, a feed tube 42, a slide body 39 (in dashed lines), and a locking collar 36 used to securely mount the attachment to the tool. The slide body 39 has a slide rail 38 (also sometimes referred to herein as a nosepiece rail) attached thereto which includes a screw length selector 41 (a series of slotted openings in the slide rail), and exhibits a nosepiece 28. The nosepiece 28 is mounted proximal to an exit end 34 of the tool. The screw length selector 41 can be adjusted by sliding it back or forth in a slot, or opening, 40, until the desired setting is reached, and then the nosepiece 28 is locked at that screw length setting until the user adjusts it again. A flexible collated strip of screws 32 is fed through the guide 30 and just behind the nosepiece 28 during operation. Although the flexible collated strip of screws is illustrated herein, a non-flexible collated strip of screws could also be used with a different type of guide. A knob 58 is used to adjust a depth of drive setting 57.

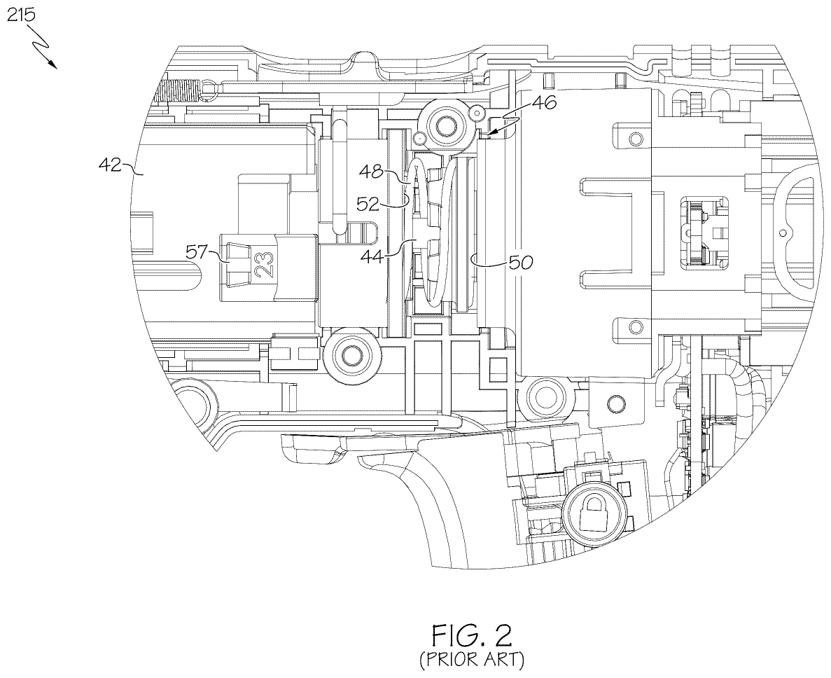

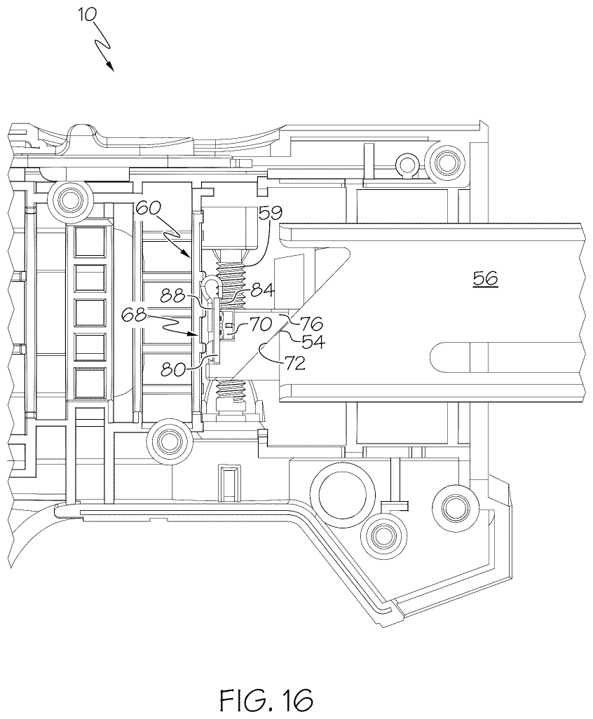

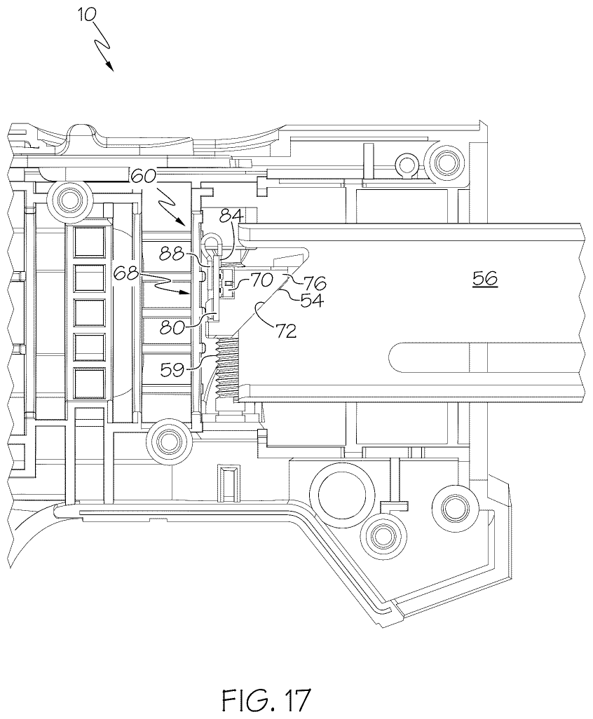

To operate the tool 10, a user initially sets the depth of drive setting 57 and sets the screw length selector 41. Then, the user loads the collated strip of screws 32 through the guide 30 and through the nosepiece 28 proximal to the exit end 34. Next, the user presses the trigger 24 that actuates a motor 94 (see FIG. 14), which starts rotating a drive bit 44 (see FIG. 2), and then positions the exit end 34 over a workpiece at an intended target. The user then pushes the exit end 34 onto the workpiece, and keeps pushing to force the slide body 39 back into the feed tube 42, until the rear portion of the slide rail 38, and the rear of the slide body 39 contacts a depth of drive block 76 (see FIGS. 16-17). It should be noted that, while the nosepiece 28 is adjustable using the screw length selector 41, the slide body 39, the slide rail 38, and the nosepiece 28 move together as one during operation of the tool 10.

In typical conventional (prior art) autofeed screwdriving tools, the drive bit 44 never stops rotating while the trigger 24 is depressed, and the clutch 46 (see FIG. 2) is typically used to stop the drive bit 44 once a screw has been driven into a substrate and the depth of drive block 76 has been reached. The clutch 46 includes a spring 48, and this spring is biased to separate a first contact surface 50 from a second contact surface 52. Once the user has finished driving a screw, the user releases the exit end 34 from the workpiece. At this point, the slide body 39 begins to automatically extend and, at the same time, the spring 48 exerts a biasing force to split the first contact surface 50 from the second contact surface 52, thereby releasing the clutch 46 and allowing the drive bit 44 to begin rotating again.

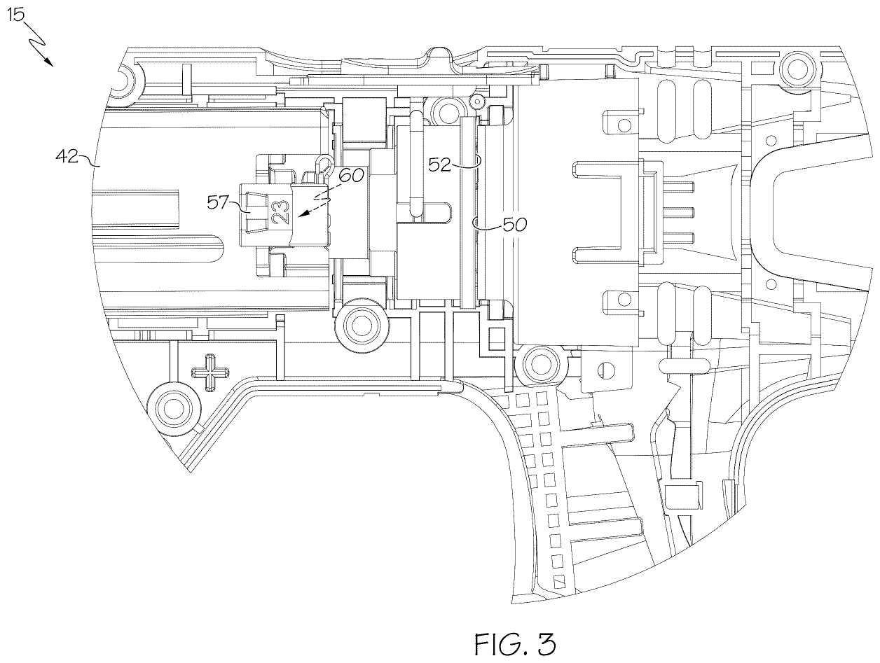

Referring now to FIG. 3, the tool 10 having a clutchless design is illustrated. In this clutchless design, the first contact surface 50 and the second contact surface 52 are always in contact with each other, as depicted in FIG. 3. Removing the clutch saves about 12.7 mm in length (0.5 inches) and also reduces the weight of the tool by a small amount. This clutchless design allows the drive bit 44 to start and stop due to a motor cutoff subassembly (“S/A”) 60, as will be discussed in greater detail further below.

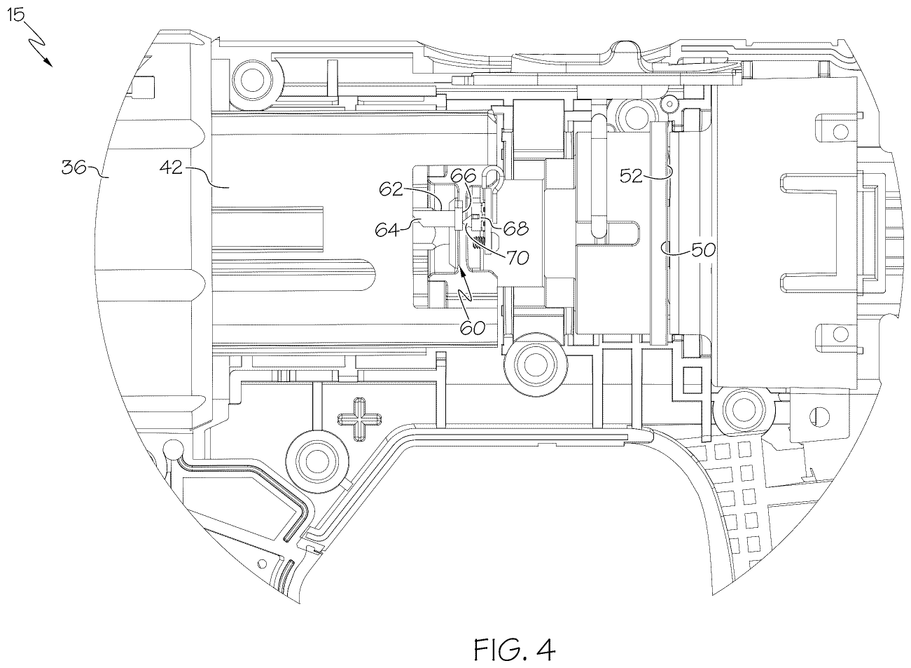

Referring now to FIG. 4, the motor cutoff S/A 60 includes a plunger 62 having a first end 64 and an opposite, second end 66, and a sensor 68 including a switch 70. When the second end 66 of the plunger 62 is moved into contact with the switch 70 (i.e., at or near the end of a driving stroke), the switch is depressed and causes the sensor 68 to send a message (or a signal) to an onboard microprocessor 90 (i.e., the system controller—see FIG. 14), and the microprocessor determines that a driven position has been reached. The microprocessor 90 then sends a signal to stop the motor 94 (which disables electrical current to the motor, which deactivates the motor), which also stops the drive bit 44 from rotating—i.e., the drive bit is also temporarily disabled. As long as the switch 70 is depressed, the motor 94 will remain turned off, thereby saving energy between each driving stroke (i.e., securing one screw onto a workpiece). It should be noted that the sensor 68 depicted in FIG. 4 is a contact sensor, which includes a small limit switch 70 with an electromechanical contact, and thus the sensor 68 comprises a contact sensor subassembly. Alternatively, the sensor 68 could be a non-contact sensor, such as a Hall-effect sensor, for example.

It will be understood that, if a non-contact sensor is used rather than the illustrated contact sensor 68, then the rear portion of the slide body could be detected directly by such a non-contact sensor—e.g., without the use of a plunger 62. In such an alternative arrangement, at or near the end of the driving stroke, the rear portion of the slide body would move proximal to the sensor until the sensor detects the presence of that rear portion, which would then cause the sensor to output a first signal to the system controller (or merely change state), which would then stop the motor from rotating the drive bit. Then, during at least a portion of the return stroke, the rear portion of the slide body would move distally away from the sensor until the sensor no longer detects the presence of that rear portion, which would then cause the sensor to output a second signal to the system controller (or merely change state), which would then allow the motor to again rotate the drive bit, if the trigger is pulled by the user.

Once the user releases the tool 10 from the workpiece, the slide body 39 begins to extend (i.e., during at least a portion of a return stroke), thereby moving the plunger 62 out of contact with the switch 70. The sensor 68 now sends a second signal to the microprocessor 90, and the microprocessor determines that a return stroke is occurring (i.e., the tool resets to a ready position in order to drive a new screw). If another driving stroke is to then occur, the microprocessor will send a signal to start the motor 94, which then begins rotating the drive bit 44. During each driving stroke and each return stroke (i.e., one cycle), the motor 94 is started and stopped, thus reducing power consumption in the tool 10, and thereby increasing the number of screws that can be driven on a single battery charge.

It will be understood that the terms “first signal” and “second signal” in the above description can represent either an actual data signal that is output by the sensor 68, or a change of state in a simple digital signal that is output by the sensor 68. If sensor 68 comprises a limit switch, for example, then its output signal would likely be either an “on” state or an “off” state, and thus, the “first signal” would then comprise a change of state from “off” to “on”, for example, and therefore, the “second signal” would then comprise a change of state from “on” back to “off”. The actual signal values for such “on” and “off” states would depend on the voltage and current levels used by the system controller and/or its I/O interface circuit, and perhaps also on the voltage and current levels required by the motor driver circuit 92.

In the prior art autofeed tool (see FIG. 2), the motor is typically always running as long as the trigger is engaged. After a screw has been driven into a surface, the conventional (prior art) clutch 46 slips and stops the drive bit from rotating, while the motor is still running. However, the present invention motor 94 is shut off once a screw has been driven into a surface. This not only stops the drive bit 44 from rotating, but also saves energy because the motor 94 is temporarily turned off, instead of the constantly running motor in the conventional (prior art) autofeed tool.

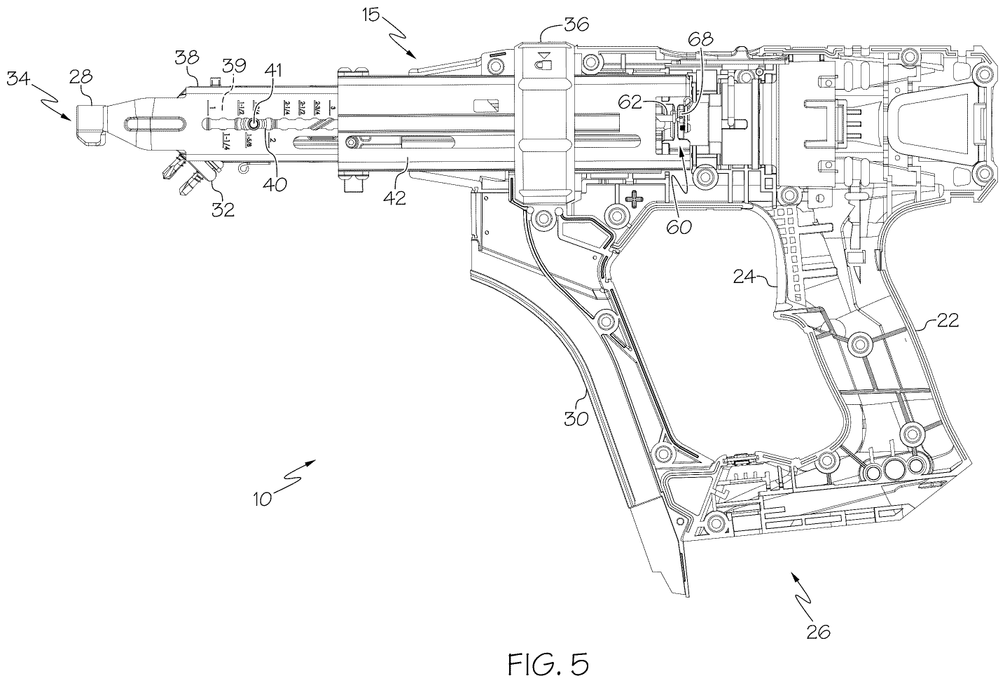

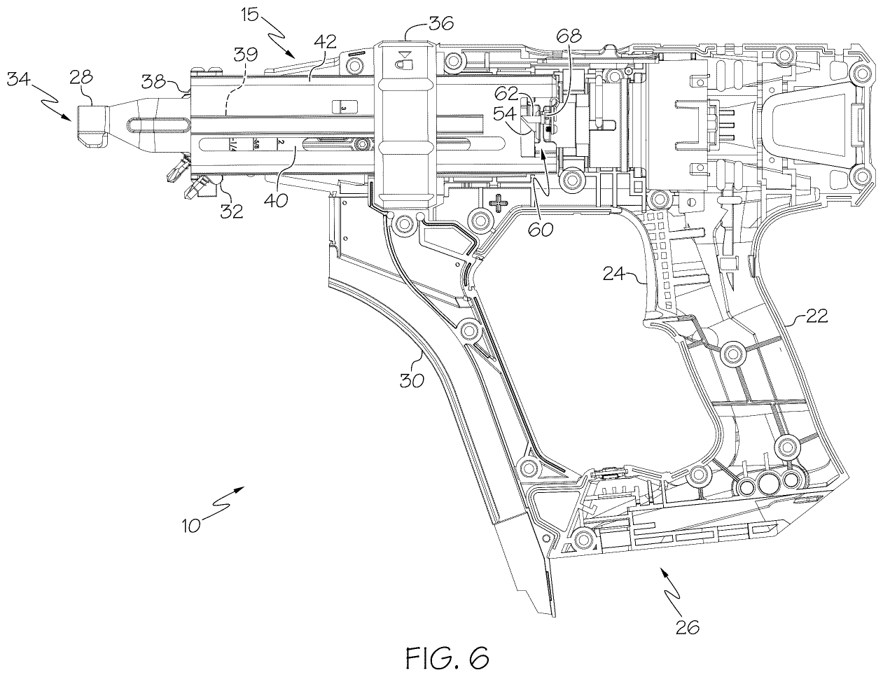

Referring now to FIG. 5, the tool 10 is depicted at the ready position, in which the tool is ready to begin driving a screw into a workpiece. At this location, the motor cutoff S/A 60 will not be contacted by a rear portion, or rear edge, 54 (see FIG. 6) of the slide body 39 until at or near the end of a driving stroke, after a screw has been fully inserted into a workpiece.

Referring now to FIG. 6, the tool 10 is illustrated showing a driven position, in which a screw has been fully inserted into a workpiece. In FIG. 6, the slide body 39 has been fully depressed onto a workpiece until it contacts the depth of drive block 76. As the slide body 39 contacts the depth of drive block 76, the rear portion 54 contacts the first end 64 of the plunger 62, which forces the plunger's second end 66 into contact with the switch actuation lever 78 of the sensor subassembly 68. At the driven position, the sensor 68 effectively sends a signal to the microprocessor 90 to stop the motor 94, thereby stopping the rotation of the drive bit 44.

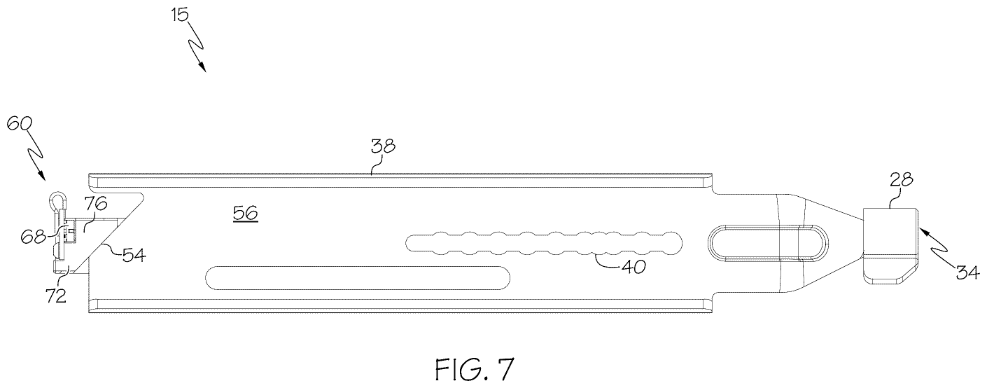

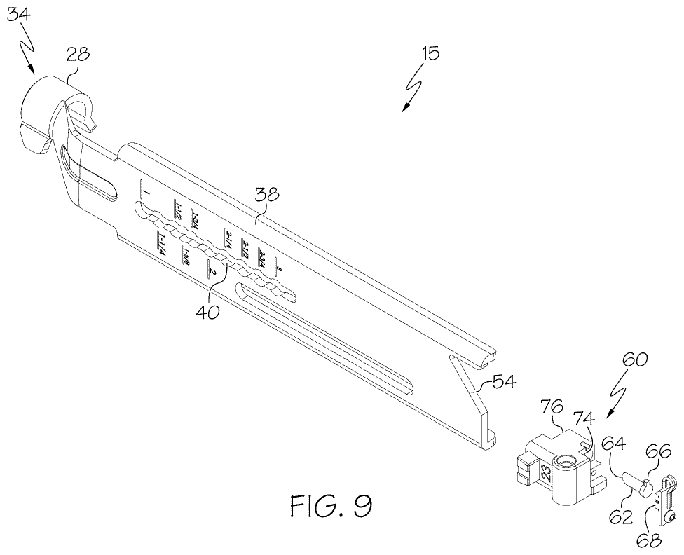

Referring now to FIG. 7, the nosepiece 28 and the motor cutoff S/A 60 are spatially depicted in the “driven position.” The motor cutoff S/A 60 includes the depth of drive block 76 in which the plunger 62 and the sensor subassembly 68 are mounted on. The depth of drive block 76 exhibits a stop portion 72 that is contacted by the rear portion 54 of the slide rail 38, and an opening 74 (see FIG. 9) for the plunger 62 to slide within.

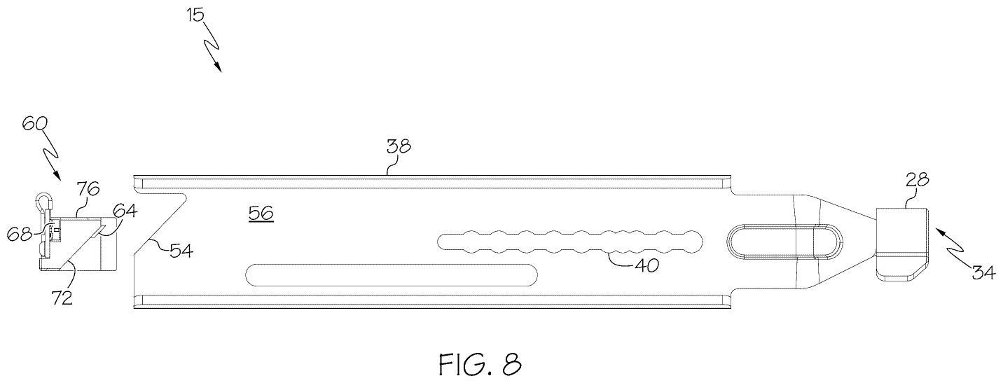

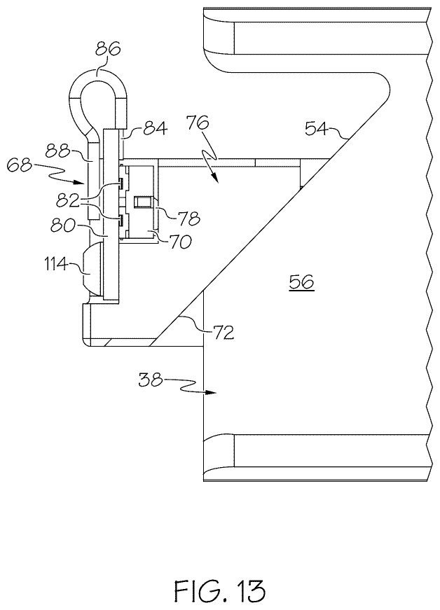

Referring now to FIG. 8, the nosepiece 28 and the motor cutoff S/A 60 are spatially depicted in the “ready position.” The first end 64 of the plunger 62 is depicted protruding from the opening 74 of the depth of drive block 76. Note that, when in the “driven position,” the rear portion 54 contacts both the stop portion 72 and the first end 64 of the plunger 62 (see FIG. 7 and FIG. 13), and the rear portion 54 has moved the second end 66 of the plunger 62 into contact with the switch actuation lever 78.

Referring now to FIG. 9, the opening 74 in the depth of drive block 76 is depicted, and the plunger 62 is movably seated and slides back and forth inside this opening 74 during operation of the tool 10. When the tool 10 is in the driven position, the rear portion 54 forces the plunger 62 rearwards and into contact with the switch actuation lever 78. Then, once the tool 10 is lifted off the workpiece, the slide body 39 begins to automatically extend (it is spring-loaded), which simultaneously moves the rear portion 54 out of contact with the plunger 62. The switch actuation lever 78 (which is spring-loaded) then forces the plunger 62 to move in an opposite direction so that it releases and therefore becomes out of contact with the sensor subassembly 68.

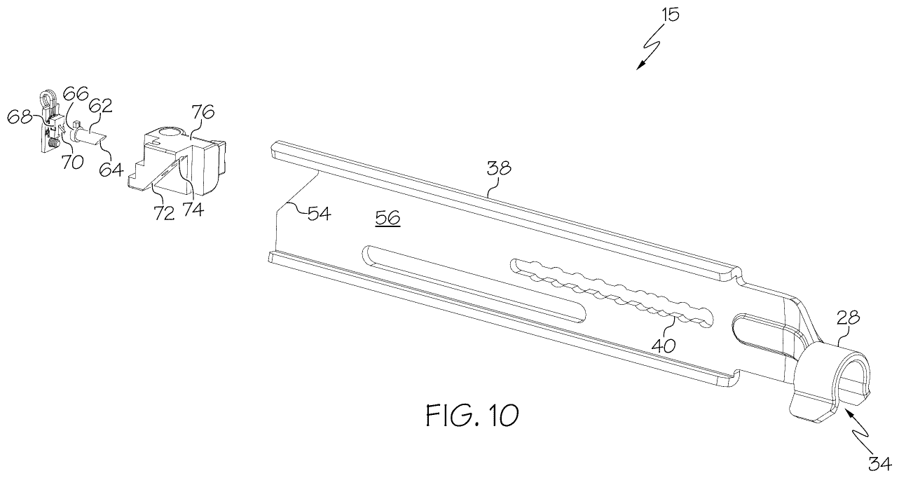

Referring now to FIG. 10, the switch 70 is depicted in its non-actuated state, in which the plunger 62 is not contacting the switch actuation lever 78. (In this exploded view, the slide rail 38 is illustrated as not being in its rear-most position.) The opening 74 and the stop portion 72 are also depicted as portions of the depth of drive block 76.

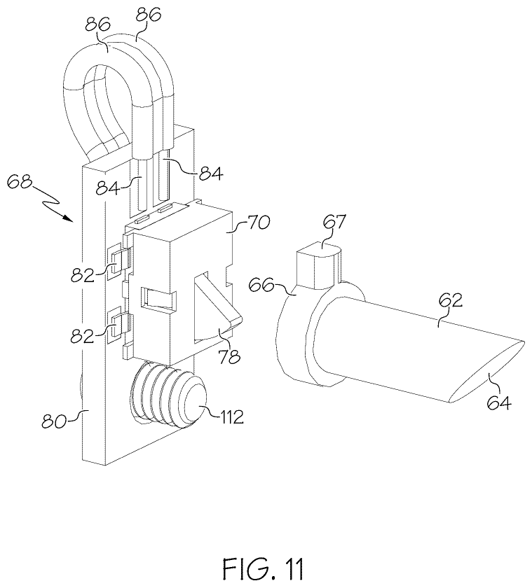

FIGS. 11-13 are provided to illustrate some of the details that were described above, in a magnified set of views. Starting with FIG. 11, the Depth of Drive sensor subassembly 68 is depicted from a rear, upper, and side quarter view (with respect to the overall tool 10), in which the plunger 62 is illustrated as being separated (spaced apart) from the sensor body, but also being in line with the switch actuation lever 78.

The plunger 62 is shown in its entirety, having a first end 64, which is sloped, a second end 66, and an alignment tab 67 at the second end. The sloped (angled) first end 64 is sized and shaped to make ‘smooth’ contact with the similarly angled rear edge 54 of the slide rail 38, when that slide rail is pushed ‘backwards’ by the slide body 39 being pushed in by the nosepiece actuation. When that occurs, the slide rail's movements will force the plunger toward the switch actuation lever 78.

The second end 66 of the plunger is sized and shaped to make physical contact with the switch actuation lever 78, which will ultimately force the switch 70 to change state, as described above. It will be understood that FIG. 11 is a somewhat exploded view, and the distance between the plunger's second end 66 and the switch actuation lever 78 is not exactly to scale. In other words, the distance the plunger needs to move to contact the switch actuation lever 78 may be much closer together than depicted here, mainly for the purpose of clearly showing some of the construction details.

The sensor subassembly 68 in this illustrated embodiment of FIG. 11 uses an electromechanical switch to detect the motion of the plunger 62. As noted above, the second end 66 of the plunger is designed to make physical contact with the switch actuation lever 78, which will then force the switch contacts (not visible in this view) to change state. It will be understood that virtually any type of motion sensor could be used in this engineering application, including non-contact sensors, such as an optical sensor, a Hall effect (magnetic field) sensor, or a metal sensing proximity sensor (if a metal part is to be detected).

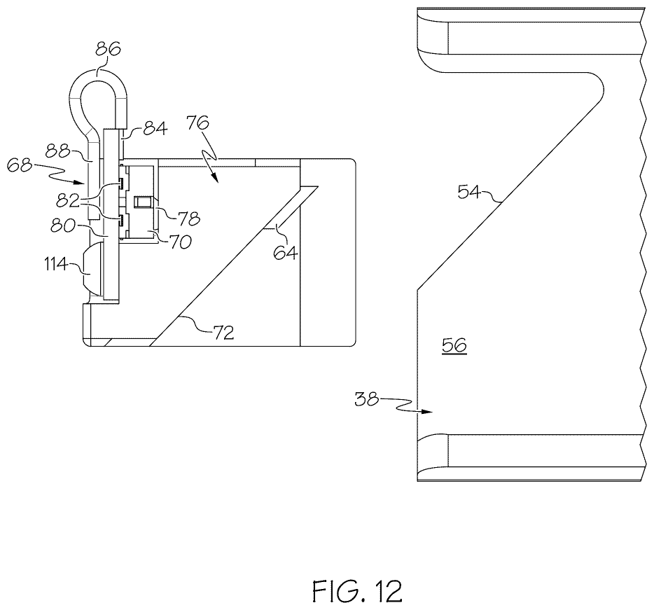

On FIG. 11, the sensor 68 includes a switch body 70, which has the electrical contacts therewithin, the switch's actuation lever 78, which typically is an integral part of the switch, and a printed circuit (PC) board 80. (Note that FIGS. 12-13 show many of these same details.) There are two solder tabs 82 on the PC board, which are used for mounting the switch body 70 to the PC board. A pair of wires are run to the switch, in which the wires are depicted as bare (stripped) leads at 84, a set of loops at 86 to provide strain relief, and a relatively straight portion at 88 (see FIGS. 12-13). A screw is used to hold the PC board 80 to a depth of drive block 76 (see FIGS. 12-13), and the threads are depicted at 112.

Referring now to FIG. 12, the sensor 68 is depicted as being mounted onto the depth of drive block 76, by use of the screw discussed above, in which the screw head is shown at 114. In this view, the plunger's first end 64 is visible as protruding a short distance from the sloped (angled) surface 72 of the depth of drive block 76. The slide rail 38 is also illustrated in this view, and it exhibits a sloped (angled) rear edge 54 that is sized and shaped to match up to the similarly angled first end 64 of the plunger. The main outer surface of the slide rail is also depicted at reference numeral 56. This is the non-actuated state of the sensor 68, because the rear edge 54 of the slide rail 38 is not making physical contact with the plunger 62. This illustrates the ‘normal’ state of the tool 10 at its rest position, and also shows (but not to scale) all operating states of the tool except when the slide body 39 has been pushed almost all the way into the feed tube 42—at least, up to the limiting adjustment of the Depth of Drive adjustable setting at 57.

Referring now to FIG. 13, the sensor 68 is again depicted as being mounted onto the depth of drive block 76, by use of the screw discussed above. In this view, the plunger's first end 64 is no longer visible because the rear edge 54 of the slide rail 38 has bottomed out against the sloped (angled) surface 72 of the depth of drive block 76. As can be seen in this view, the sloped (angled) rear edge 54 of the slide rail is now essentially co-linear with the sloped surface 72. This is the actuated state of the sensor 68, because the rear edge 54 of the slide rail 38 is making physical contact with the plunger 62, and has forced that plunger to the left (in this view), where the opposite side (i.e., the second end 66) of the plunger will actuate the switch 70. Since the plunger 62 travels through an opening in the depth of drive block 76, the plunger itself is not visible from this side view. This illustrates the ‘driven’ position, or state, of the tool 10, which occurs when the slide body 39 has been pushed into the feed tube 42, up to the point where the Depth of Drive adjustable setting at 57 has come into play. At this point of the slide body travel, the screw should be entirely driven into the target substrate of its workpiece.

### System Controller

Referring now to FIG. 14, a schematic block diagram of some of the major electrical and electronic components of the tool 10 (see FIG. 1) are generally depicted by the reference numeral 100. As with most modern sophisticated products, a system controller (i.e., an integrated circuit) is provided to properly control the tool 10 so as to operate only when predetermined conditions exist. The microprocessor 90 (also sometimes referred to herein as a “microcontroller” chip) is provided to act as that system controller.

All microcontrollers (and microprocessors) include a central processing unit (a “CPU”), which performs the necessary logic and mathematic functions, according to an executable computer program. The executable computer program itself is typically stored in a Read Only Memory chip (a “ROM”), which is on-board the microcontroller chip. If the computer program is so large that it cannot fit in the on-board ROM, then an additional ROM chip may be added to the hardware of this block diagram 100, but that usually is not necessary.

Most (or all) microcontrollers also include on-board Random Access Memory (“RAM”), which is also known as Read/Write Memory, and is used for temporary storage of data or other variable information that needs to be made available to the CPU when executing the computer program stored in the ROM portion of the system's overall memory. If there is insufficient RAM on-board the microcontroller chip, then additional RAM chip(s) may be added—as needed—to the hardware of this block diagram 100. The number and type of memory chips will typically be determined by the system designer of the computer program, and depends on the size and sophistication of the microcontroller chip itself, as well as the size of the executable computer program and the amount of data that is to be stored in the memory circuits. It will be understood that there are hundreds, if not thousands, of different types of microcontroller chips available in today's technology, and that the system designer will be required to select a proper chip model, and to correctly write the computer program that is to be used for this system controller.

So far, only the main “computing components” of the microcontroller 90 have been discussed herein. Typical microcontrollers also include other types of on-board circuits as well, such as inputs and outputs. Such inputs and outputs are also typically referred to as “I/O” devices, and they can be interfaced with either analog signals or digital signals, depending on the type of microcontroller chip being used.

It will be further understood that the above description of a system controller and its major on-board components will be applicable to multiple different types of tools and other computerized devices, and that every modern electrical engineer will have knowledge of how to apply such microprocessor or microcontroller chips, by referring to the user manuals that are always provided by the manufacturers of such chips. However, the computer program (also known as “software”) that must be “loaded” into memory of such chips is always a specialized, custom entity in and of itself, and that software is the key to causing a computerized product to work properly.

### Inputs

In the electromechanical portion of the circuit 100, the trigger 24 and the depth of drive sensor 68 are both depicted as “inputs” of the microcontroller chip 90. The trigger 24 is also illustrated on FIG. 1, and is user-actuated. The depth of drive sensor 68 is illustrated on FIG. 4, and is actuated at or near the end of the driving stroke, after the front end (i.e., the slide body 39 and the nosepiece 28) of the tool 10 is pressed with sufficient force against a target substrate, such as a piece of wood or metal, and the slide body 39 has been fully retracted (i.e., the slide body has been fully pushed into the feed tube 42).

When the sensor 68 is actuated, it sends a first signal to the microprocessor 90, and from that information the microprocessor determines that a driven position of the tool 10 has been reached by the slide body. The microprocessor 90 then sends a signal to the motor driver circuit 92 to turn off the motor 94. When the motor 94 is turned off, the drive bit 44 stops rotating (see the mechanical portion of FIG. 14).

The microprocessor 90 can also be programmed to track each first signal sent by the sensor 68. This tracking allows the tool 10 to count each screw driven, or determine the number of cycles, allowing for regular maintenance schedules to be automatically determined by the microprocessor 90, based on preprogrammed parameters. For example, after every 10,000 screws have been driven (or 10,000 cycles), the tool could be programmed to signal the user that the drive bit 44 should be serviced, or perhaps that the sensor 68 may need to be replaced. The parameters can be set to whatever the tool's system designers deem appropriate.

Once the user finishes driving a screw, he or she will lift the tool off of the substrate, which means the slide body 39 (see the mechanical portion of FIG. 14) will automatically start to extend. (It is spring-loaded.) At the same time, the sensor 68 will de-actuate and send a second signal to the microprocessor 90, and the microprocessor determines that the tool 10 is ready to drive another screw. If the nosepiece 28 is again actuated (and especially if the user continues to hold down the trigger), the microprocessor 90 will then send a signal to the motor driver circuit 92 to start the motor 94. When the motor 94 is started, the drive bit 44 starts rotating again. These operations may occur so fast that the motor essentially never stops rotating.

Alternatively, the electrical circuit of the tool could be configured so that the sensor 68 directly sends a signal to the motor driver circuit 92, instead of going through the system controller 90. It should also be noted that the sensor 68 may comprise a limit switch, for example, and the “signals” that the sensor sends are merely electrical direct current. For example, if using a normally open contact, a limit switch would allow current to pass through that contact once the switch is actuated, whereas in a resting (open) state, no current would flow. Of course, if a solid state sensor is used (instead of an electromechanical limit switch), the designer of the tool would likely choose the state of the sensor in which the output current is at its lowest magnitude. It will be understood that solid state sensor generates an output signal, typically either a voltage or a current signal.

The system controller 90, or the motor driver circuit 92, is operable to detect which state the sensor 68 is configured in, and then either detects current flow, or does not, based on that configuration. Then, the motor 94 is turned on, or turned off, depending on that current flow detection.

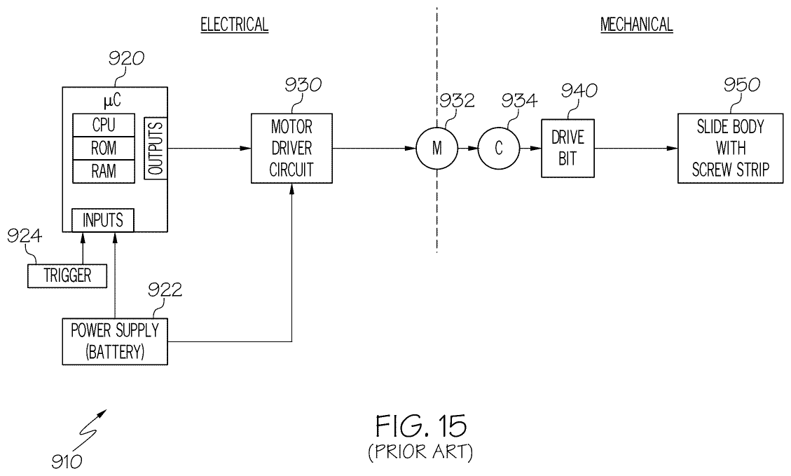

As a comparison, a block diagram of a prior art autofeed screwdriving tool is provided in FIG. 15, which is generally designated by the reference numeral 910. Many of the circuit components in FIG. 15 are similar, or the same, as like components found in FIG. 14. For example, there is a system controller 920, which includes either a microprocessor or a microcontroller with a CPU, ROM, RAM, and a capability to interface with input and output signals. A DC power supply 922 is included, which for a portable power tool, would typically be a battery or battery pack, and this DC power would likely be supplied both to the system controller 920 and to a motor driver circuit 930.

A trigger sensor 924 is included, which when actuated by a user, will send a signal to the system controller 920 to start a motor 922, which is accomplished by a signal sent by the system controller to the motor driver circuit 930. The typical microprocessor or microcontroller will be unable to directly supply a motor with sufficient current, so the motor driver circuit 930 is designed to receive a (low voltage and low current) signal from the system controller, and when thus activated, the motor driver circuit will provide the necessary higher voltage and higher current to the motor 932, using energy from the battery 922. In most motor driver circuits, one or more high power switching transistors (or other type of switchable semiconductor devices) are used to turn on, or off, the power feed to the motor.

In the block diagram 910, the motor 932 drives a clutch 934, which then rotates a drive bit 940 to rotate a screw (not shown in this view). A slide body 950 that has a rotatable sprocket with a screw strip having collated screws (not shown) is ‘pushed’ into a feed tube (not shown), so that the drive bit 940 will soon make physical contact with the ‘lead screw’ of the collated screwstrip, and that lead screw will have its head engaged by the drive bit, and thus the screw will begin rotating. Except for the clutch 934, most of these components are similar or identical to those components by the same nomenclature that were found in the block diagram 100, on FIG. 14. But this is a significant difference: the prior art design of FIG. 15 has a clutch, and the new design of FIG. 14 does not.

Many users of automatic screwdriving power tools tend to keep the trigger actuated as they move from one screw location to another, which wastes energy. Moreover, many of those same users also tend to keep the screwdriving power tool pushed in against the workpiece longer than necessary, probably to make sure that the screw has been fully seated into that workpiece. However, this also wastes energy, and the clutch 934 allows this behavior to occur without any unfortunate physical consequences, except for the extra energy that has been wasted.

On the other hand, the new design depicted in the block diagram 100 of FIG. 14 eliminates this loss of energy by automatically turning off the motor 94 when the screw has been fully seated into its target workpiece. Not only is energy saved because there is no ‘extra spinning’ of the motor after the screw has been seated, which a tool with a clutch does not avoid, but also energy is saved between driving strokes, because the motor 94 is turned off even if the trigger 24 remains actuated by the user. This overall energy savings can be significant.

Referring now to FIG. 16, the depth of drive block 76 is depicted at a first setting. When a user desires to adjust the depth of drive block 76, the knob 58 is rotated which actuates a worm screw 59 that is in mechanical communication with the depth of drive block 76. If the knob 58 is a rotated in one direction, the depth of drive block 76 will move “down” (in this view). Alternatively, if the knob 58 is rotated in the opposite direction, the depth of drive block 76 will move “up” (in this view), as depicted on FIG. 17.

Referring now to FIG. 17, the depth of drive block 76 is depicted at a second, different setting than that shown in FIG. 16. The depth of drive block 76 is adjustable along nearly the full length of the worm screw 59. When the knob 58 is rotated and the depth of drive block 76 is moved, the depth of drive setting 57 will also move to visually show the user the depth of drive setting.

### Optional Alternative Embodiment

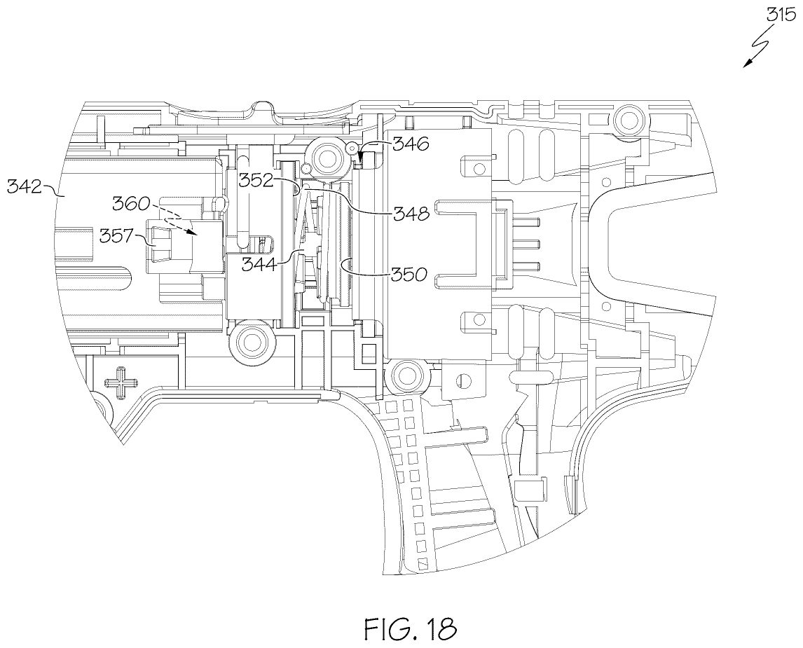

Referring now to FIG. 18, an attachment for an automatic screwdriver is generally designated by the reference numeral 315. A clutch 346 is included in this optional embodiment, in which the clutch is released (disengaged) to allow a drive bit 344 to stop rotating once a screw has been driven into a substrate. At about the same time, a depth of drive sensor 360 will have been actuated. The clutch 346 includes a spring, which is biased to separate a first contact surface 350 from a second contact surface 352. Once the user has finished driving a screw, the user releases an exit end of the tool (not shown in this view) from the workpiece. At this point, a slide body (not shown in this view) begins to automatically extend (it is spring-loaded by a spring 348) and, at the same time, the clutch spring exerts its biasing force to split the first contact surface 350 from the second contact surface 352, and the clutch 346 becomes disengaged. The drive bit 344 does not begin rotating again until a new screw is placed on the drive bit (by the ‘backward’ motion of the slide body), and at this point the clutch 346 engages and the drive bit begins rotating for the next driving stroke.

A depth of drive setting 357 is mounted on a feed tube 342, and the depth of drive sensor 360 is secured to one side of the depth of drive setting 357. In this alternative embodiment attachment 315, the sensor 360 would initiate a motor cutoff, and the clutch 346 would stop the drive bit 344 from spinning. (The deactivation of the motor would also stop the drive bit from rotating, but the clutch may do it quicker.) The sensor 360 would also be used to count driving strokes by notifying the system controller when a driving stroke is “complete” (i.e., after a screw has been driven).

As noted above, the sensor 360 will act as a “motor cutoff sensor,” and will deactivate the motor after the sensor 360 determines that the drive cycle has been completed for a given screw. This deactivation of the motor will occur, even if the user keeps his or her finger on the trigger (which, otherwise, could keep the motor activated, as in many conventional automatic screwdriver tools). In this manner, electrical energy will be saved, especially because many users will keep the trigger actuated between driving strokes when using automatic screwdriver tools. (Many users believe that it's easier to keep the trigger ‘pulled’ all the time, when in a hurry to drive several screws into different locations of a workpiece.)

Some of the mechanical mechanisms described above for the portable fastener driving tool 10 have been available in the past from Senco Products, Inc. and Senco Brands, Inc., including such tools as the Senco Model Nos. DS162-14V and DS200-14V. Some of the components used in the technology disclosed herein have been disclosed in commonly-assigned patents or patent applications, including a U.S. Pat. No. 5,988,026, titled SCREW FEED AND DRIVER FOR A SCREW DRIVING TOOL; a U.S. Pat. No. 7,032,482, titled TENSIONING DEVICE APPARATUS FOR A BOTTOM FEED SCREW DRIVING TOOL FOR USE WITH COLLATED SCREWS; a U.S. Pat. No. 7,082,857, titled SLIDING RAIL CONTAINMENT DEVICE FOR FLEXIBLE COLLATED SCREWS USED WITH A TOP FEED SCREW DRIVING TOOL; a U.S. Pat. No. 8,869,656, titled SCREWDRIVER TOOL WITH IMPROVED CORNER FIT FUNCTION; a U.S. Pat. No. 8,627,749, titled SCREWDRIVER TOOL WITH IMPROVED CORNER FIT FUNCTION; and a U.S. Pat. No. 8,726,765, titled SCREWDRIVER TOOL WITH IMPROVED LINEAR TRACKING. These patent properties have been assigned to Senco Brands, Inc., or to Kyocera Senco Industrial Tools, Inc., and their disclosures are incorporated herein by reference in their entireties.

Note that some of the embodiments illustrated herein do not have all of their components included on some of the figures herein, for purposes of clarity. To see examples of such outer housings and other components, especially for earlier designs, the reader is directed to other U.S. patents and applications owned by Senco. Similarly, information about “how” the electronic controller operates to control the functions of the tool is found in other U.S. patents and applications owned by Senco. Moreover, other aspects of the present tool technology may have been present in earlier fastener driving tools sold by the Assignee, Kyocera Senco Industrial Tools, Inc., including information disclosed in previous U.S. patents and published applications.

It will be further understood that any type of product described herein that has moving parts, or that performs functions (such as computers with processing circuits and memory circuits), should be considered a “machine,” and not merely as some inanimate apparatus. Such “machine” devices should automatically include power tools, printers, electronic locks, and the like, as those example devices each have certain moving parts. Moreover, a computerized device that performs useful functions should also be considered a machine, and such terminology is often used to describe many such devices; for example, a solid-state telephone answering machine may have no moving parts, yet it is commonly called a “machine” because it performs well-known useful functions.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two (male and female) structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two (male and female) structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

What is claimed is:

1. A method for controlling a drive bit for an autofeed screwdriving tool, the method comprising:
providing:
a handle portion with a user-operated trigger;
a motor and a corresponding motor driver circuit;
an electrical power source;
a system controller, operable to control the tool;
a slide body exhibiting an exit end and an opposite, rear portion;
a flexible collated strip of screws;
a rotatable drive bit; and
a motor cutoff subassembly, comprising:
a plunger; and
a sensor that detects a position of the plunger;
engaging the user-operated trigger;
starting the rotatable drive bit, by energizing the motor;
pressing the slide body against a work surface, until the rear portion contacts and moves the plunger until detected by the sensor;
sending, using the sensor, a first signal; and
stopping the rotatable drive bit without the use of a clutch.

2. The method of claim 1, further comprising:
lifting the slide body away from the work surface;
moving the rear portion out of contact with the plunger;
moving the plunger away from the sensor;
sending a second signal, using the sensor;
enabling the rotatable drive bit; and
if the trigger is actuated, then starting the rotatable drive bit.

3. The method of claim 2, wherein:
the sensor is configured to send the first signal and the second signal to at least one of:
the system controller; and
the motor driver circuit.

4. The method of claim 1, wherein: when the user-operated trigger is engaged and the slide body is pressed onto the work surface, one screw of the flexible collated strip of screws is driven into the work surface.

5. The method of claim 3, further comprising:
providing a feed tube; and
pressing the slide body onto the work surface, causing the slide body to retract into the feed tube; and
lifting the slide body off of the work surface, allowing the slide body to automatically extend due to a biasing force provided by a spring.

6. The method of claim 1, wherein: the electrical power source comprises a rechargeable battery pack.

7. The method of claim 2, wherein: at least one of the first signal and the second signal provides a count of the driving strokes of the tool.

8. An autofeed screwdriving tool, comprising:
a handle portion with a user-operated trigger;
a motor and a corresponding motor driver circuit;
an electrical power source;
a system controller, operable to control the tool;
a slide body exhibiting an exit end and an opposite, rear portion, in which the slide body is movably positioned in a feed tube;
a flexible collated strip of screws;
a drive bit that rotates when the motor is energized; and
a motor cutoff subassembly, comprising:
a plunger; and
a sensor that detects a position of the plunger;
wherein:
at or near the end of a driving stroke, the rear portion contacts and moves the plunger until the plunger is detected by the sensor, which stops the rotatable drive bit without the use of a clutch; and
during at least a portion of a return stroke, the rear portion releases from contact with the plunger, allowing the plunger to move away from the sensor, and if the trigger is actuated, starting the rotatable drive bit.

9. The tool of claim 8, further comprising:
the sensor sends a first signal when the plunger contacts the sensor; and
the sensor sends a second signal when the plunger releases from contact with the sensor.

10. The tool of claim 9, wherein:
when the system controller receives the first signal, the system controller is operable to stop the rotatable drive bit; and
when the system controller receives the second signal, the system controller is operable to start the rotatable drive bit.

11. The tool of claim 9, wherein: at least one of the first signal and the second signal is used to provide a count of the driving strokes of the tool.

12. The tool of claim 8, wherein: the sensor is one of a contact sensor and a non-contact sensor.

13. The tool of claim 8, further comprising:
a block exhibiting a stop portion and an opening; wherein:
the plunger movably seats within the opening; and
the stop portion is in contact with the rear portion when the slide body is pressed onto a work surface.

14. The tool of claim 8, wherein: the sensor comprises a switch.

15. The tool of claim 14, wherein: when pressing the slide body onto a work surface, at or near the end of a driving stroke, the rear portion contacts and moves the plunger into contact with the switch.

16. The tool of claim 15, wherein: during at least a portion of a return stroke, the rear portion releases from contact with the plunger, allowing the plunger to move out of contact with the switch.

17. The tool of claim 16, wherein: if the trigger is actuated, then starting the rotatable drive bit.

18. An autofeed screwdriving tool, comprising:
a handle portion with a user-operated trigger;
a motor with a corresponding motor driver circuit;
a removably attachable battery;
a system controller, operable to control the tool;
a slide body exhibiting an exit end and an opposite, rear portion, in which the slide body is movably positioned in a feed tube;
a flexible collated strip of screws;
a drive bit that rotates when the motor is energized; and
a motor cutoff subassembly, comprising:
a sensor that detects a position of the rear portion of the slide body;
wherein:
at or near the end of a driving stroke, using a signal from the sensor, the rotatable drive bit is stopped without the use of a clutch, and during at least a portion of a return stroke the rotatable drive bit is started if the user-operated trigger is actuated; and
the tool exhibits a reduction in its power consumption between the end of the driving stroke and the start of the return stroke, because the motor is temporarily disabled during this time period.

19. The tool of claim 18, wherein: at or near the end of the driving stroke, the rear portion makes contact with the sensor; and
during at least a portion of the return stroke, the rear portion releases from contact with the sensor.

20. The tool of claim 18, wherein: the sensor is configured to send a signal to at least one of:
the system controller; and
the motor driver circuit.

21. The tool of claim 20, wherein:
when the system controller receives a first change of state in the signal, the system controller disables electrical current to the motor; and
when the system controller receives a second change of state in the signal, the system controller enables electrical current to the motor.

22. The tool of claim 18, wherein: the sensor comprises one of: a contact sensor or a non-contact sensor.

23. The tool of claim 18, wherein: at or near the end of the driving stroke, the rear portion moves proximal to the sensor; and
during at least a portion of the return stroke, the rear portion moves distally away from the sensor.

24. The tool of claim 18, wherein: the sensor signal is used to provide a count of the driving strokes of the tool.

25. An autofeed screwdriving tool, comprising:
a handle portion with a user-operated trigger;
a motor and a corresponding motor driver circuit;
an electrical power source;
a system controller, operable to control the tool;
a slide body exhibiting an exit end and an opposite, rear portion, in which the slide body is movably positioned in a feed tube;
a flexible collated strip of screws;
a drive bit that rotates when the motor is energized; and
a motor cutoff subassembly, comprising:
a plunger that is movable; and
a sensor that detects a position of the plunger;
wherein:
at or near the end of a driving stroke, the rear portion contacts and moves the plunger until the plunger is detected by the sensor; and
the sensor sends a first signal.

26. The tool of claim 25, further comprising:
during at least a portion of a return stroke, the rear portion releases from contact with the plunger; and
the sensor sends a second signal.

27. The tool of claim 26, wherein:
the sensor is configured to send the first signal and the second signal to at least one of:
the system controller; and
the motor driver circuit.

28. The tool of claim 27, wherein:
when the rear portion contacts and moves the plunger until detected by the sensor, the electrical power to the motor is temporarily deactivated; and
when the rear portion releases from contact with the plunger, the electrical power is allowed to actuate the motor.

29. The tool of claim 25, wherein: the electrical power source comprises a rechargeable battery pack.

30. The tool of claim 25, wherein: the sensor is one of: a contact sensor or a non-contact sensor.

31. The tool of claim 26, wherein: at least one of the first signal and the second signal is used to provide a count of the driving strokes of the tool.
